(19) United States
(12) Patent Application Publication
(10) Pub. No.: US 2015/0197049 A1
(43) Pub. Date: Jul. 16, 2015

(54) SIDE GATING HOT RUNNER NOZZLE AND ASSOCIATED FLOATING MANIFOLD SEALS

(71) Applicant: Otto Maenner Innovation GmbH, Bahlingen (DE)

(72) Inventor: Gheorghe George Olaru, Freiburg (DE)

(21) Appl. No.: 14/599,113

(22) Filed: Jan. 16, 2015

Related U.S. Application Data
(60) Provisional application No. 61/928,005, filed on Jan. 16, 2014.

(51) Int. Cl. B29C 45/27

(52) U.S. Cl. CPC B29C 45/2708; B29C 2045/2683

(57) ABSTRACT

A side gating hot runner injection molding apparatus may include a manifold, several hot runner nozzles coupled to the output melt channels of the manifold, and several corresponding molding cavities. Each injection nozzle may be securely locked in a fixed position by a nozzle head flange portion. The manifold may include floating manifold seals positioned at each manifold output melt channel. The manifold seals may include a telescopic or sliding extension having a melt channel. A biasing element may be positioned between the manifold and the upper surface of the floating manifold seal. The manifold may freely slide laterally with respect to the fixed nozzles and together with the manifold seals that are coupled to the manifold via the telescopic or sliding connection while maintaining the seal in both cold and hot conditions.

### CROSS-REFERENCE TO RELATED APPLICATIONS

This application claims benefit of priority from U.S. Provisional Patent Application No. 61/928,005, filed Jan. 16, 2014, which is hereby incorporated by reference in its entirety herein.

### FIELD

The present disclosure relates to a hot runner injection molding apparatus and methods of injection molding. More particularly, this disclosure is related to a side or edge gating hot runner injection molding apparatus with a multipurpose manifold to nozzle seal and methods of injection molding using this apparatus.

### BACKGROUND

Hot runner injection molding systems and methods of injection molding using hot runner injection molding systems are known.

Side gating or edge gating hot runner injection molding systems and methods of injection molding using side gating or edge gating hot runner injection molding systems are also known.

Unlike the most common axial injection molding systems using hot runners, in the side or edge gating molding systems using hot runner nozzles the molten material is injected into the mold cavity along a lateral or angular direction relative to the central axis of the mold core of the mold cavity.

If the edge gating hot runner nozzles uses nozzle tip seals secured or locked into an opening around the mold gate, the entire nozzle is locked and is prevented from moving in both axial and lateral directions.

A major issue in side gating or edge gating hot runner is related to the thermal expansions of the manifolds and nozzles on both vertical and lateral directions and the need to provide a better sealing between the nozzles and the manifolds and around the nozzle tips.

Solutions have been proposed to address the thermal expansion issues in side gating hot runners, where for example the hot runner nozzle body is split into parts that can move axially relative to each other through the use of sliding or telescopic connections. In other cases, the nozzle body can slide in a vertical direction, which in most cases is perpendicular or angled with respect to the direction of injection into the cavity, while other components of the nozzle are locked using additional elements or features to prevent the melt leakage.

The thermal lateral expansion of the manifold is in fact a lateral translation relative to the nozzles that are locked in a fixed position by the nozzle tip seals. The translation of the manifold requires an advanced finish and smooth roughness of the manifolds lower surface to allow them to slide over the head portion of the nozzle or over a nozzle to manifold seal. The side gating prior art in the record does not solve the issue of the manifold lateral translation relative to the fix hot runner nozzles in a manner that facilitates this translation without any risk of leakage between the manifold and the nozzle in both cold and hot conditions.

In cold conditions caused by the interruption of molding, this leakage prevention is even more critical since the molten material is still fluid and the manifold and the nozzle contact, providing thus gaps for the melt to leak.

At the same time there is a need to ensure that the hot runner nozzles coupled to the manifold can expand freely due to thermal expansion in a direction perpendicular to the lateral translation of the manifold, while the nozzles are locked by the nozzle tips.

Furthermore, because in side gating molding the hot runner nozzles are locked by the nozzle tip seals, if the manifolds deflect chances for leakage of molten material between the nozzles and the manifolds are higher and the prior art of record failed to address this issue in combination with the thermal growth and movements of the manifold and the nozzles along perpendicular directions.

Another issue related to the known side gating hot runners is related to the need to better control the heat loss at the mold gate caused by the direct contact between the nozzle seal and the mold. If the temperature around the nozzle tips and at the gate is not optimum for the specific molding process and or for the specific material to be molded the resulted part may have defects. Also the start-up process of a side gating hot runner system becomes problematic and or time consuming if the temperature of the molten material at the tip or at the mold gate is not proper for the specific application.

Furthermore, there is another need to further improve side gating with hot runners, related to blocking the flow of a molten material from at least one nozzle tip towards a mold cavity.

There is a need to further improve the design of the side gating or edge gating hot runner injection molding systems.

There is a need to better compensate for the thermal expansions of the nozzles and manifolds and thus insure improved sealing between the nozzle and the manifold and around the nozzle tips within wider temperature processing windows where the molten material performs within its required characteristics.

There is a need to allow the manifold to slide laterally relative to the nozzle without engaging the nozzle in this movement.

There is also a need to allow the manifold to grow or expand on along vertical axial direction without applying an additional force onto the nozzle tips and seals locked at the mold gates.

There is a need to improve the interaction between the manifold and the nozzles surface finish to facilitate the sliding of the manifolds even after many injection cycles and many months in operation without increasing the time to make the manifolds, the use expansive equipment or use costly materials that allow for a better finish but are not proper for the other characteristics of the manifold.

Lastly, there is a further need to improve the heat profile of the side gated nozzles, and especially at the head portion of the nozzle and the tip portion of the nozzles where there is a contact and heat loss to the adjacent mold plates, while preserving all the other specification mentioned before for side gating.

### SUMMARY

According to one aspect of the present disclosure, a side gating hot runner apparatus may include a heated manifold having an inlet melt channel and several outlet melt channels. Each outlet melt channel may communicate with a hot runner nozzle having a nozzle head and a main melt channel and at least two angled melt channels communicating with at least two nozzle tips, each tip being retained in a fixed position around a corresponding mold gate. The nozzle may be heated by a first nozzle heater. A nozzle to manifold seal may be located between the nozzle and the manifold, the seal optionally including a telescopic extension movable inside a manifold outlet melt channel. A biasing element may be located between the manifold seal and the manifold and may apply a variable sealing force between the nozzle head and the manifold seal. The nozzle seal may be able to move without restriction laterally and vertically due to the thermal expansion of the manifold and nozzle. Using the manifold seal and the biasing element may reduce or eliminate forces acting on the nozzle tips and nozzle seals and may allow the nozzle to freely expand vertically along its own axis and the manifold to freely expand vertically and laterally.

A side gating hot runner injection molding apparatus may include a manifold, hot runner nozzles coupled to the output melt channels of the manifold, and several molding cavities. The manifold may be heated by at least one manifold heater and the temperature of the manifold may be monitored and measured by a manifold temperature sensor, such as for example a thermocouple.

The hot runners may have a head portion, a head flange portion, a body portion, and a tip portion. The tip portion may include one, two, or several nozzle tips and nozzle tip seals corresponding to an equal number of mold gates and mold cavities. The nozzle tips may be located adjacent the mold gate orifices of the mold cavities.

Each injection nozzle may be securely locked in a fixed position by the nozzle head flange portion that may be supported by a mold plate and by the nozzle tip seals that may make a sealing contact with an opening adjacent each mold gate orifice.

Each nozzle may include at least one nozzle heater and at least one temperature sensor (e.g., a thermocouple).

A controller may be used to adjust the temperature of the manifold and the nozzles and to monitor the injection molding process.

During the startup process, the temperature of the manifold and the nozzles may increase from the room temperature to the operating temperature, which may be specific to: (a) each resin to be processed, (b) the volume of the cavity, and (c) the injection pressure.

During service or for other reasons, the manifold and the nozzle heaters may be turned off. In all of these situations, the manifold and the nozzle may have thermal expansions or contractions mainly along two perpendicular directions.

There may be inherent temperature variations across the manifold, along each hot runner nozzle, at the gates, and between each molding cavity.

According to the embodiments of the present disclosure, the manifold may include floating manifold seals positioned at each manifold output melt channel. The manifold seals may include a telescopic or a sliding portion having a melt channel portion that may protrude inside the manifold output melt channel. The sliding or telescopic portion may allow the manifold seal to move inside the manifold output melt channel. The sliding or telescopic portion of the manifold seal may also allow the seal to move laterally when the manifold has a thermal expansion or contraction. Furthermore, the manifold seal may include a seating surface that may allow the manifold to be supported by the hot runner nozzles without contacting directly the nozzle head portion of the nozzles. This seating surface of the manifold seal may also provide an optimum sliding surface for the lateral movement of the manifold during thermal expansion or contraction. This is because (a) the manifold seal may be made of a different material than the manifold, or (b) the surface finish of the seating surface of the manifold seal may have a roughness as defined in ASME and DIN that is more adequate for sliding than the surface finish of the manifold, which may be rougher due to the less demanding manufacturing requirements.

According to the embodiments of the present disclosure, a biasing element may be positioned between the manifold and the upper surface of the manifold seal. The biasing element may be installed in a gap or in a pocket created to accommodate the vertical or axial displacements of the manifold and the nozzles due to thermal expansion or contraction. Because the floating manifold seal may include the telescopic or sliding portion with its melt channel there may be no leakage between the manifold and the manifold seal.

According to the embodiments of the present disclosure, the floating manifold seal may be positioned on top of the nozzle heat portion that may be secured in a fixed position by the nozzle head flange and the nozzle tip seals.

According to the embodiments of the present disclosure, the biasing element may provide a sealing force between the manifold and the nozzle head portion via the floating manifold seal whose seating surface may contact the seating surface of the nozzle head.

According to the embodiments of the present disclosure, the manifold floating seal may have several functions suitable for the side gating nozzles: (a) providing indirect sealing between the manifold output melt channels and the nozzle melt channels, (b) allowing the manifold and the nozzle to expand due to thermal expansion, (c) allowing the manifold to slide laterally relative to the nozzles without engaging the nozzles, (d) providing separate seating and sliding surfaces for the manifold, the seating surface of the manifold seal having a better roughness than the roughness of the manifold, (e) allowing for better heat profile since it can incorporate separate heaters from the manifold heaters, and (f) allowing for the better insulation of the nozzle head from the manifold.

According to the embodiments of the present disclosure, a side gating hot runner injection molding apparatus may include a manifold, several hot runner nozzles coupled to the output melt channels of the manifold, and several corresponding molding cavities. Each injection nozzle may be securely locked in a fixed position by a nozzle head flange portion that may be supported by a mold plate and by nozzle tip seals that may make a sealing contact with an opening adjacent mold gate orifice. The manifold may include floating manifold seals positioned at each manifold output melt channel. The manifold seals may include a telescopic or a sliding extension having a melt channel that may protrude from the manifold output melt channel. A biasing element may be positioned between the manifold and the upper surface of the floating manifold seal. The biasing element may be installed in a gap or in a pocket created to accommodate the vertical or axial displacements of the manifold and the nozzles due to thermal expansion or contraction and to generate a sealing force between the floating seals and the nozzles. The manifold may freely slide laterally with respect to the fixed nozzles and together with the manifold seals that are coupled to the manifold via the telescopic or sliding connection while maintaining the seal in both cold and hot conditions.

According to another aspect of the present disclosure, illustrated in FIGS. 1-2 and FIG. 9, a side gating hot runner apparatus may include a manifold and several hot runner nozzles. Each nozzle may include a nozzle body and several nozzle tips that may be locked at each mold gate. Each nozzle may be coupled. Each nozzle may include a telescopic or sliding connection to allow the nozzle to expand vertically relative to the manifold. The nozzle may be heated by a first nozzle heater and each tip may be heated by a separate second heater positioned adjacent or in the proximity of each mold gate. Each secondary heater may be controlled by a separate thermocouple.

According to another aspect of the present disclosure illustrated in FIGS. 1, 3, and 11, a side gating hot runner apparatus may include a manifold and several hot runner nozzles. Each nozzle may include a nozzle body and several nozzle tips that may be locked at each mold gate. Each nozzle may be coupled. Each nozzle may include a telescopic or sliding connection to allow the nozzle to expand vertically relative to the manifold. A mold flow blocking element, or a shut off pin, may be used in conjunction with each nozzle. The shut off pin may be either manually or automatically moved from a passive position outside the melt channel to an active position inside the melt channel.

According to another aspect of the present disclosure, an injection molding apparatus may comprise: an injection manifold having at least one manifold input melt channel and a plurality of manifold output melt channels, the manifold being heated by at least one manifold heater controlled by at least one manifold thermocouple, and wherein the manifold having an upper surface, an opposite lower surface and a lateral surface; a plurality of side gating hot runner nozzles optionally coupled to the manifold, each side gating hot runner nozzle including at least one input melt channel portion having a first axis and at least one output melt channel portion having a second axis, the second axis being inclined relative to the first axis, and wherein each of the hot runner nozzles may include a nozzle head portion, a nozzle body portion and a nozzle tip portion, the nozzles further optionally including at least one nozzle tip having a nozzle tip melt channel and an associated nozzle tip seal; a plurality of nozzle heaters and nozzle thermocouples optionally secured to each hot runner nozzle; a plurality of mold cavities that may be positioned to receive molten material from the plurality of the side gating hot runner nozzles, each mold cavity optionally having at least one mold gate orifice having a third axis and a mold gate opening to receive the nozzle tip seals; a plurality of floating manifold seals coupled to the manifold, the floating manifold seals being movable together with the manifold along a first lateral direction with respect to the fixed nozzles as a result of a thermal expansion of the manifold and being further movable relative to the manifold along a second direction as a result of thermal expansion of the nozzles, where each of the floating manifold seals being positioned between the manifold and each nozzle head portion; and a plurality of biasing elements that may be positioned in a gap or a pocket between the manifold and an upper surface of the floating manifold seals, the biasing elements optionally holding the manifold and absorbing the thermal expansion of both the manifold and the nozzles to generate a first sealing force between the nozzle head portion and the lower surface of the floating manifold seals when the nozzles, that are locked in a fixed position by the nozzle head flanges and by nozzle tips seals and when the manifold, that are supported by the biasing elements and by the nozzle heads, are heated up.

According to another aspect of the present disclosure, an injection molding apparatus for side gating moldable articles in mold cavities, may comprise: an injection manifold that may have at least one manifold input melt channel and a plurality of manifold output melt channels, the manifold optionally being heated by at least one manifold heater controlled by at least one manifold temperature sensor, and wherein the manifold may have a distal-facing surface relative to the mold cavities and an opposite proximal-facing surface; a plurality of side gating hot runner nozzles, each optionally including at least one input melt channel portion having a first axis, and wherein each of the hot runner nozzles may include a nozzle head portion, a nozzle body portion, a nozzle tip portion, at least one nozzle tip at least partially defining an output melt channel having a second axis that is inclined relative to the first axis, and a nozzle tip seal in association with each nozzle tip, wherein each nozzle may include at least one nozzle heater positioned to heat melt in the nozzle, and at least one nozzle temperature sensor optionally positioned to sense the temperature of the nozzle, wherein each nozzle tip and tip seal may be positionable in a mold gate opening proximate a mold gate orifice into an associated one of the mold cavities, so as to fix the position of the nozzle laterally and axially; a plurality of floating manifold seals optionally positioned between the manifold and the nozzle head portions of the nozzles to transfer melt from the manifold into the nozzles, wherein the manifold seals may be telescopically connected to the manifold so as to permit relative axial movement between each floating manifold seal and the manifold, wherein the telescopic connection may cause each manifold seal to move with the manifold laterally during thermal expansion and contraction of the manifold, wherein the telescopic connection may permit axial movement of the manifold relative to each manifold seal during thermal expansion and contraction of the manifold and also permits axial movement of each manifold seal relative to the manifold a result of thermal expansion of the nozzles; and a plurality of biasing elements optionally positioned to apply a biasing force to urge the floating manifold seals away from the manifold and into engagement with the nozzles.

According to another aspect of the present disclosure, an side gating hot runner apparatus may comprise: a manifold that may have a melt inlet and a plurality of melt outlets; a hot runner nozzle that may have a nozzle head and including a main melt channel and at least two angled melt channels communicating with at least two nozzle tips, each tip being retained in a fix position around a corresponding mold gate; a first nozzle heater; a nozzle to manifold seal optionally located between the nozzle and the manifold, the seal optionally including a telescopic extension movable inside a manifold outlet; and a biasing element optionally located between the manifold seal and the manifold that may apply a sealing force between the nozzle head and the manifold seal and where the nozzle seal may move without restriction laterally and vertically due to thermal expansion.

According to another aspect of the present disclosure, a method of sealing a hot runner apparatus for side gating may comprise: providing a manifold having a plurality of melt outlets; providing a plurality of side gating hot runner nozzle communicating with the outlets, each nozzle including at least one laterally positioned tip locked at a mold gate; providing a manifold seal between the nozzle and the manifold, the manifold having a telescopic or sliding connection penetrating a manifold outlet; providing a biasing element between the manifold seal and the manifold and using the biasing element to create a sealing force between the nozzle and the seal while allowing the manifold to slide along a first direction and the nozzle seal to slide along a second direction perpendicular to the first direction.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the examples depicted in the accompanying drawings. The figures are not necessarily to scale, and certain features and certain views of the figures may be shown exaggerated in scale or in schematic in the interest of clarity or conciseness.

FIGS. 1 a-b-c-d-e show several embodiments of the present disclosure, where the manifold and each nozzle are supported and locked in different ways between the mold plates. The manifold may have air pockets to receive the manifold seal and create a thinner manifold and system which reduces the tie bar space on the injection molding machine.

FIG. 2 and FIGS. 2 b-c-d-e show a nozzle according to an embodiment of the present disclosure that is used in any or all FIGS. 1a-b-c-d-e where the manifold may or may not have an air pocket and also may or may not make lateral contact with the floating manifold seal to provide heat to the nozzle head melt channel.

FIG. 3 shows an embodiment of the present disclosure shown in FIGS. 1 a-b-c-d-e where the manifold has an air pocket and also makes no lateral contact with the floating manifold seal to better insulate the nozzle head melt channel from the manifold.

FIG. 4 shows an embodiment of the present disclosure shown in FIGS. 1 a-b-c-d-e where the manifold does not have an air pocket and also makes no lateral contact with the floating manifold seal to better insulate the nozzle head melt channel from the manifold. This may reduce the cost to make the manifold but may increase the thickness of the system. The floating manifold seal may be heated by a separate heater that is controlled by a thermocouple. This may allow for an additional adjustment of the heat from one nozzle to another.

FIG. 5 shows forces generated during the thermal expansion of the manifold and nozzles and the lateral sliding of the manifold. Additional locating and insulating elements may be provided around the nozzle head and flange and at the nozzle tip portion.

FIG. 6 shows a manifold insert 50 made from a material selected to increase the sliding of the seal into the manifold melt channel and to further improve the sealing as implemented in the embodiments of the present disclosure shown in FIGS. 1a-b-c-d-e.

FIG. 7 shows the embodiments of FIGS. 4-5 plus air pockets used to reduce the contact surface between the seal and the nozzle head to facilitate the sliding of the manifold. These air pockets may also retain some of the leaked resin when the sealing is less efficient. This embodiment is also implemented in the embodiments of the present disclosure shown in FIGS. 1 a-b-c-d-e.

FIG. 8 shows the embodiment of FIG. 3 where the manifold seal has multiple output melt channels to direct the flow to separate melt channels in a single nozzle or to separate nozzles coupled to the same manifold seal and biasing element. This embodiment may also be implemented in the embodiments of the present disclosure shown in FIGS. 1 a-b-c-d-e. Also, the shut off pins 205 shown in FIG. 11 and FIGS. 11 b-c-d are applicable for this design.

FIG. 8a shows a partial cross-section view along the line marked A-A in FIG. 8 in the direction shown by the two arrows.

FIG. 9 shows the embodiment of FIG. 4 with additional heaters located at the gate area of the mold cavity to add heat to the nozzle tips or to the mold gate area.

FIG. 10 shows the embodiment of FIG. 6 where a layer may be coupled to the nozzle head to improve the lateral sliding of the seal relative to the nozzle. This sliding element may have a better wear resistance than the material of the nozzle or the manifold seal.

FIG. 10b shows an embodiment where the nozzle of FIG. 10 may have a sliding element thereon made of a material that is different from the material of the nozzle head and manifold seal.

FIG. 11 shows an embodiment where a single floating manifold seal of FIG. 8 or equivalent may be connected to a plurality of separate nozzles.

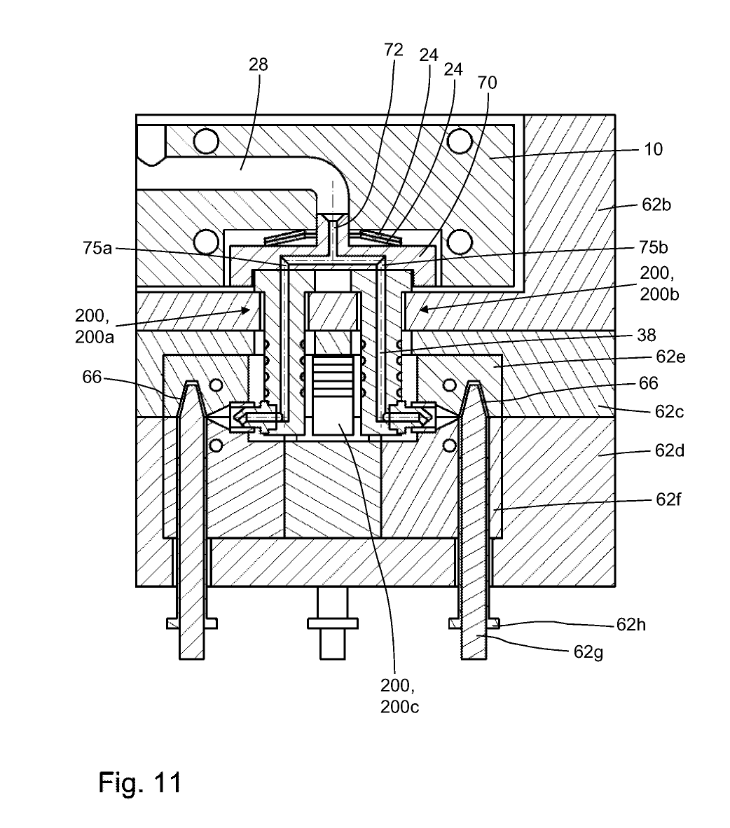

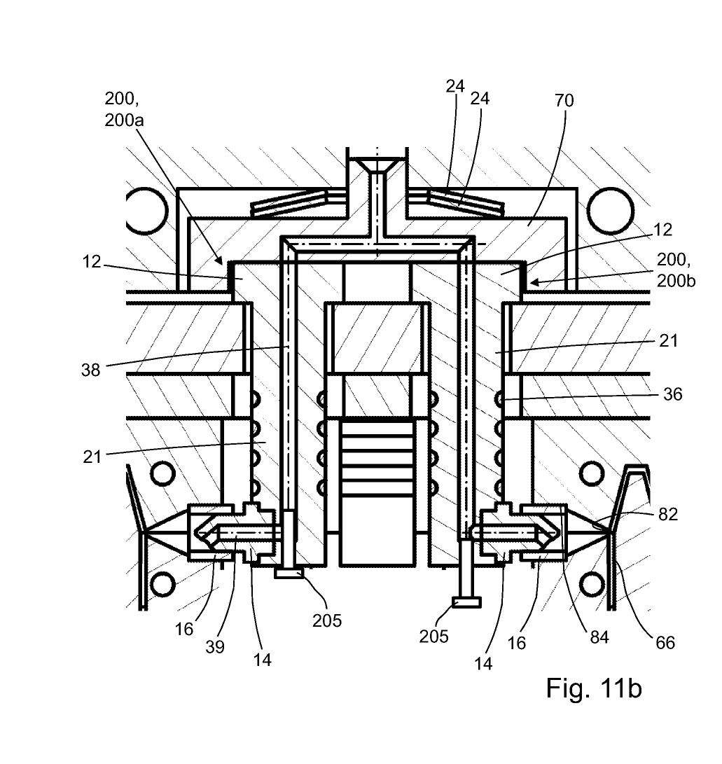

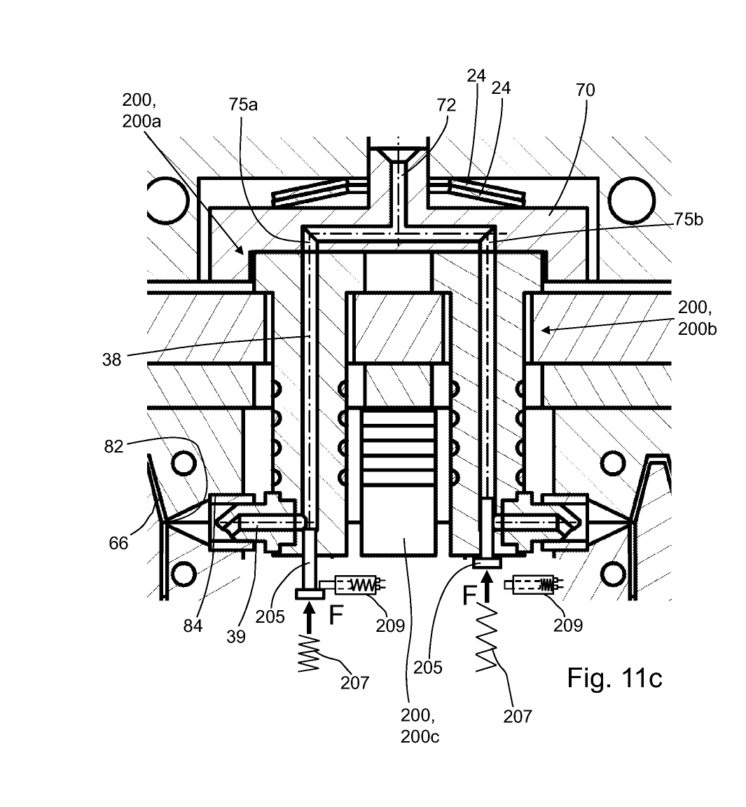

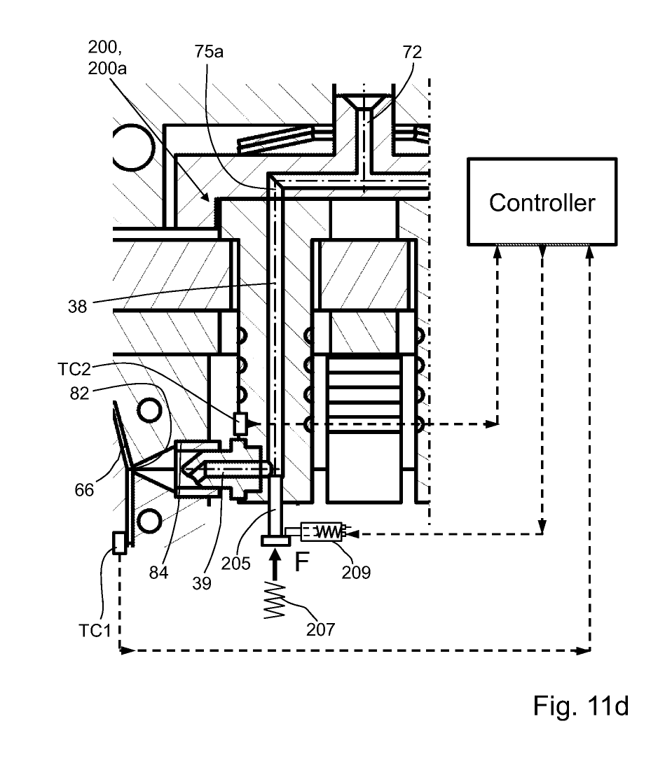

In one embodiment, shown in FIG. 11b, the shut off mechanism may be a shut off pin that can be introduced from the front side of the nozzle by an operator. In another embodiment, shown in FIG. 11c, the shut off mechanism may be a shut off pin that may be activated remotely via a controller, without stoppage of production and without a need to open the mold. Optionally, the shut off pin may be preloaded by a spring or equivalent to apply a continuous force F to a stopping element that keeps the shut off pin outside the nozzle melt channel. Optionally, in an embodiment shown in FIG. 11d, based on the information from a processing sensor or by manually pushing a button on a controller the stopping element may be destroyed or deactivated, allowing the preloaded shut off pin to enter a portion of the nozzle melt channel and block the flow on that respective gate.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

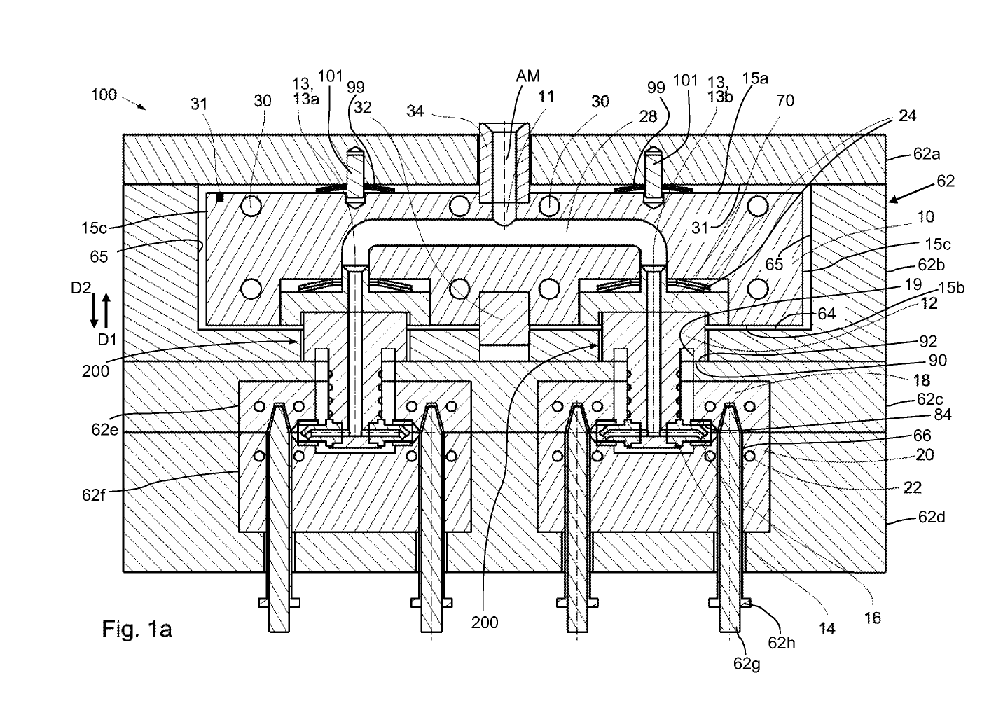

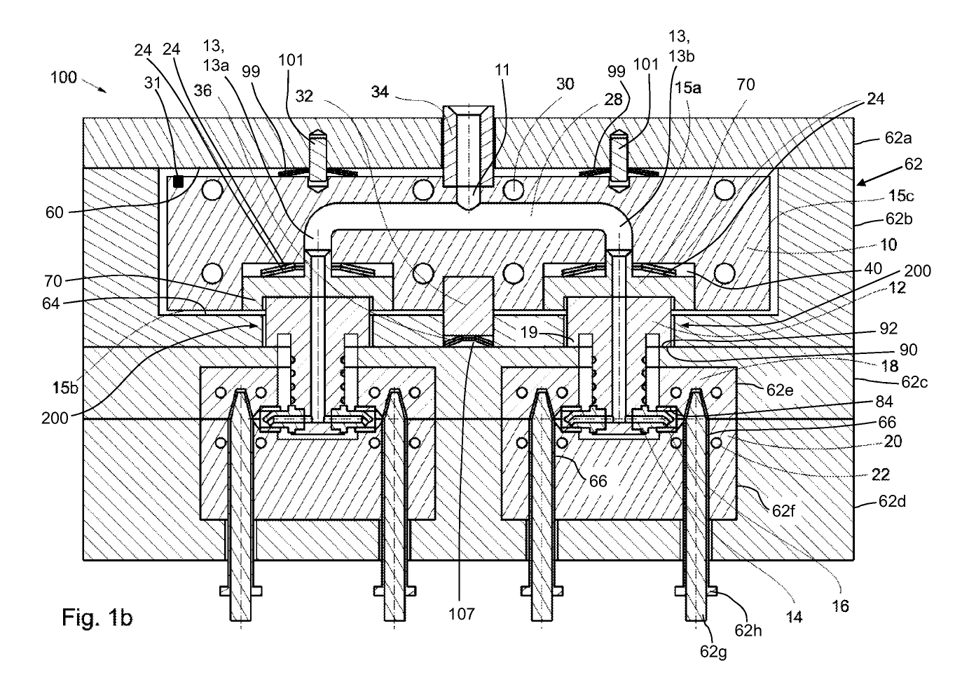

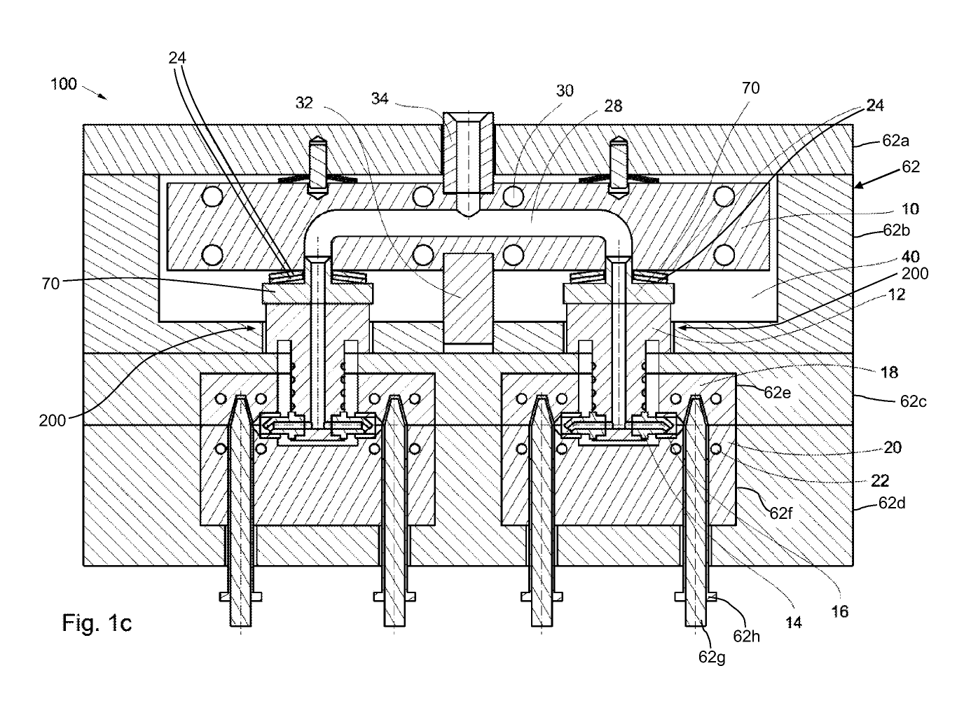

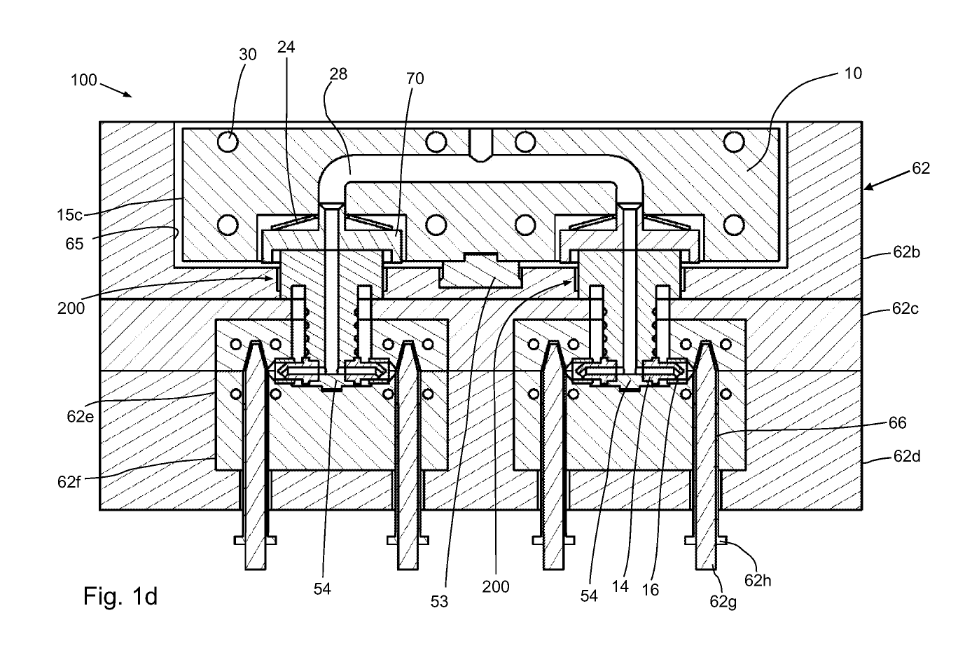

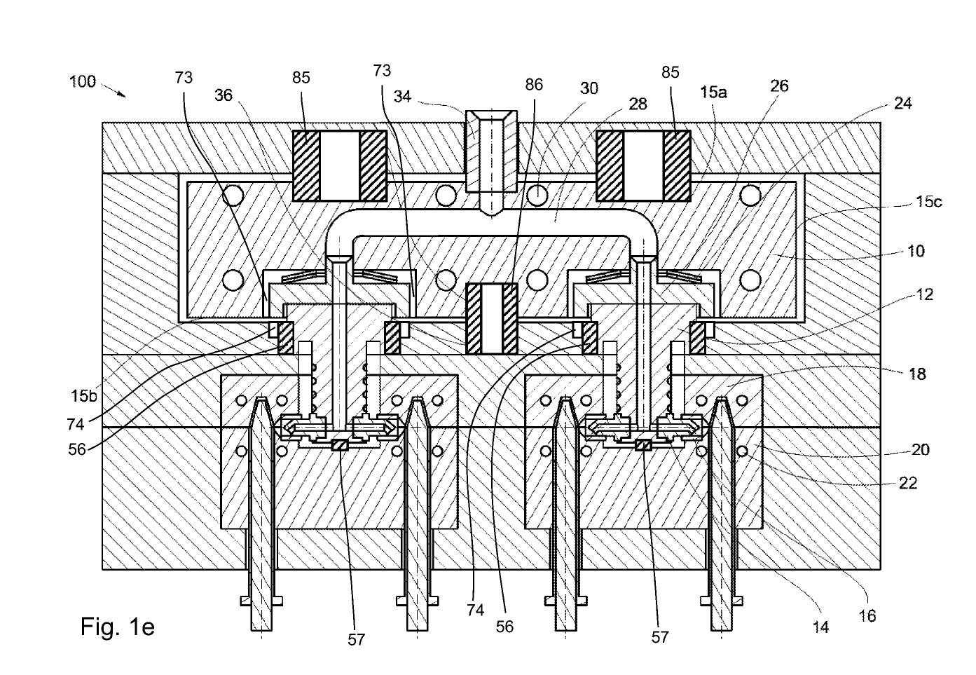

In one aspect of the present disclosure illustrated in FIGS. 1-11d an injection molding apparatus 100 includes a manifold 10 and several side gating nozzles 200. Each single side gating nozzle 200 is coupled to the manifold 10 via a single floating manifold seal 70. A biasing element 24 is located between the manifold seal and the manifold and this biasing element 24 applies a variable sealing force between the nozzle head and the manifold seal.

The floating manifold seal 70 and biasing elements 24 are designed to prevent the leakage between the nozzle and the manifold by compensating for the relative lateral thermal expansion of the manifold 70 and the relative longitudinal thermal expansion of the nozzles 200. The manifold seal 70 is referred to as a floating seal because this seal 70 can freely slide laterally along a first direction with respect to a vertical axis of the nozzle 200. This seal 70 can also freely slide vertically together with the nozzle 200 along a second direction that is perpendicular to the first direction. The manifold seal

Reference is made to FIGS. 1a-b-c-d-e that show an injection molding apparatus 100 in accordance with several embodiments of the present disclosure. While all the FIGS. have many common features, they also specific elements that are suitable for particular molten materials or molding conditions, different applications or different hot runners. In most cases, the nozzles 200 are standard side gating nozzles and the new floating manifold seals 70 are custom made components that in conjunction with the new biasing elements 24 allow the nozzles and the manifolds to expand freely laterally and vertically without generating additional forces on the nozzle tips and seals. Furthermore manifold seals 70 and biasing elements 24 provide improved sealing between the nozzles and the manifolds at the startup time, in full operation and for a wide temperature window. The floating seals 70 can have a larger diameter, the same diameter or a smaller diameter relative to the nozzle heads. The floating seal may also include a separate heater for certain applications that require a longer residence time of the melt in the manifold or when there is a heat loss at the nozzle head or when there is a need to fine tune the temperature between the nozzles. Also the way the manifold and the nozzles are locked or left floating with respect to other plates in the apparatus varies between FIGS. 1a-b-c-d-e.

The apparatus 100 includes an injection manifold 10, a plurality of side gating hot runner nozzles 200, a floating manifold seal 70 for each nozzle 200, biasing elements 24 located between the nozzles' head portion and the manifold lower surface and a mold 62. Molten material (also referred to as melt) flows from the manifold through the floating manifold seals 70, through the nozzles 200, and into mold cavities 66 in the mold 62.

The manifold 10 has at least one manifold input melt channel 11, a hot runner melt channel system 28 and a plurality of manifold output melt channels 13 (shown individually at 13a and 13b in the embodiment shown in FIG. 1a. The manifold 10 is heated by at least one manifold heater 30, which may be, for example, a fluid passage system that permits the flow of heated liquid therethrough. The temperature of the manifold 10 may be determined by at least one manifold temperature sensor 31 (e.g., a thermocouple) that transmits signals indicative of the manifold temperature to a control system (not shown). The controller controls the operation of the manifold heater 30 based on data from the temperature sensor 31. The molding apparatus 100 has a longitudinal molding apparatus axis AM.

The manifold 10 has an upper, or distal-facing surface 15a, an opposite lower, or proximal-facing surface 15b and first and second lateral surfaces 15c. In the embodiments described herein, the term distal-facing refers to a surface facing axially away from mold cavities (i.e., in a first direction shown by D1 in FIG. 1), and the term proximal-facing refers to a surface that faces axially towards the mold cavities 66 (i.e., in a second direction shown by D2). It will be understood that references to up and down (e.g., upper, lower, upwards, downwards, and the like) are in reference to the views shown in the relevant figures and are not intended to be limiting. The upper surface 15a faces a first mold plate surface 60 in a first mold plate 62a. The lower surface 15b faces a second mold plate surface 64 in a second mold plate 62b. The first and second lateral surfaces 15c face first and second lateral mold plate surfaces 65, which are also in the second mold plate 62b.

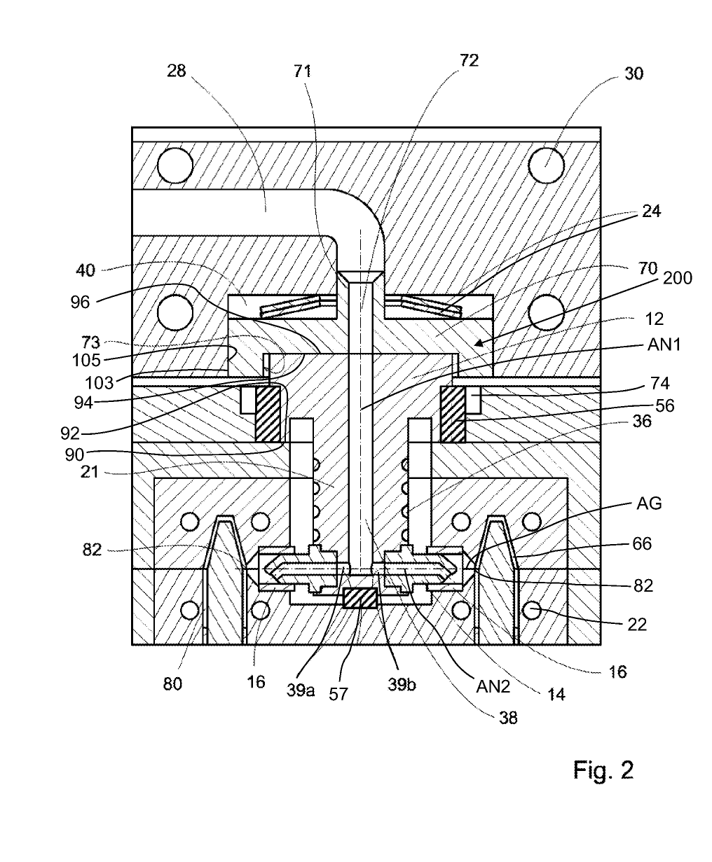

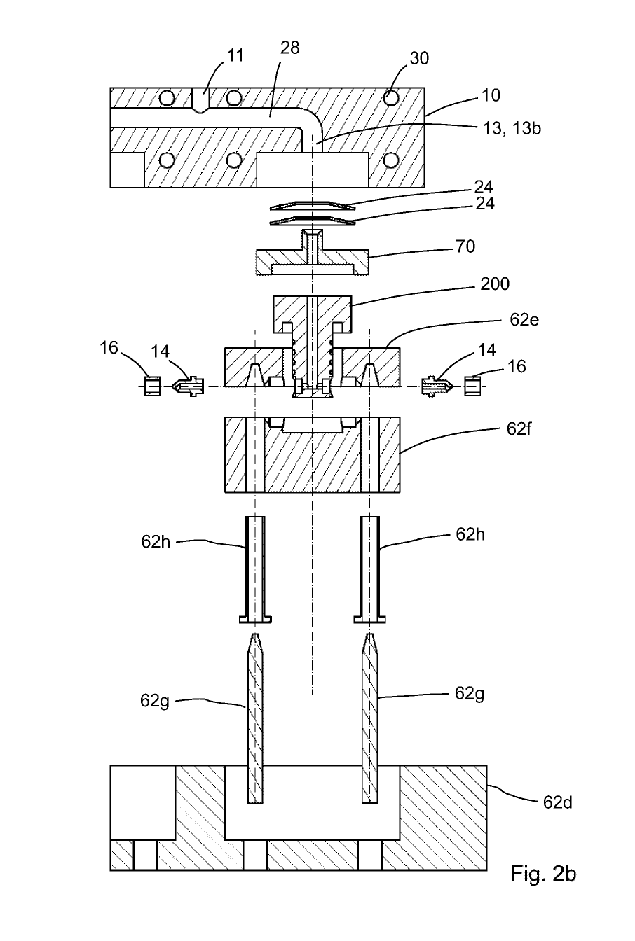

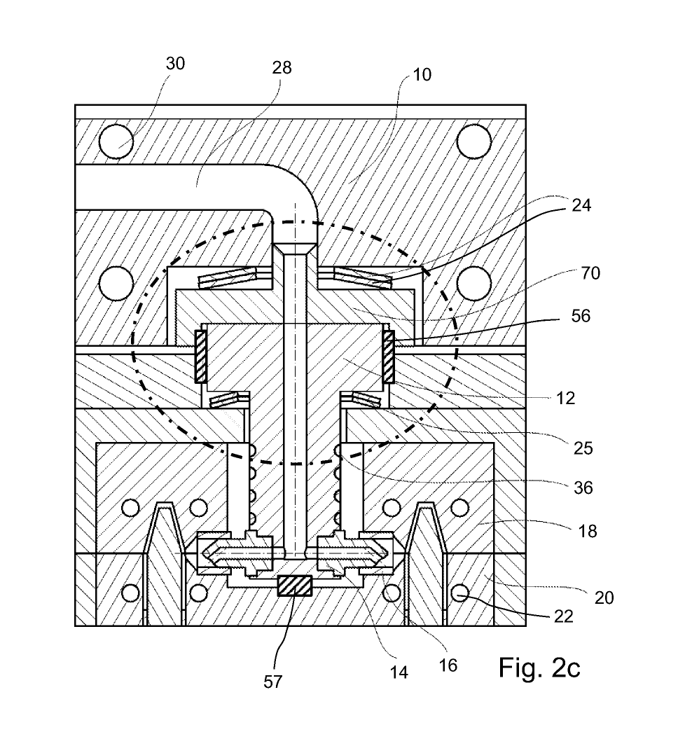

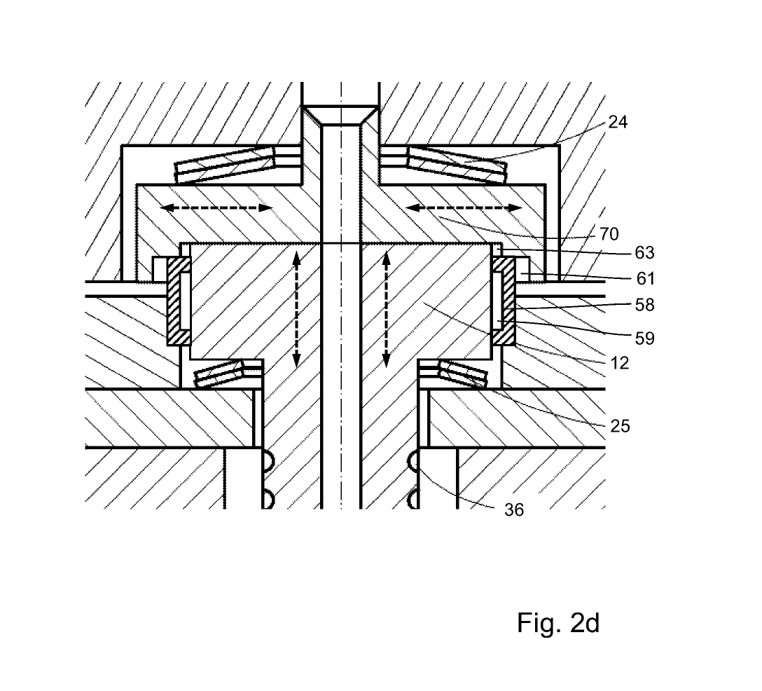

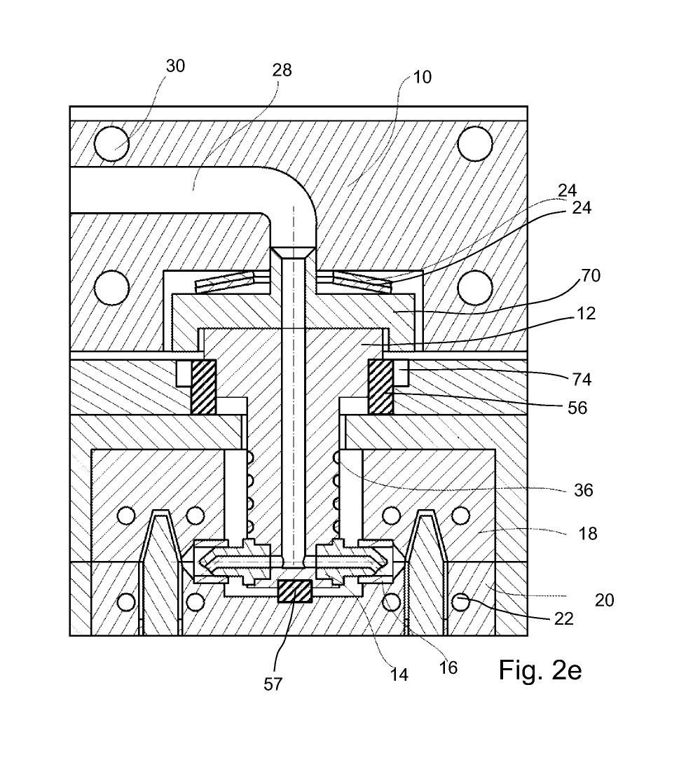

A plurality of side gating hot runner nozzles 200 are coupled to the manifold 10. With reference to FIG. 2, each side gating hot runner nozzle 200 includes at least one nozzle input melt channel portion 38 having a first axis AN1 and at least one output melt channel portion 39 having a second axis AN2, the second axis AN2 being inclined relative to the first axis AN1. In the example shown in FIG. 2, there is one input melt channel portion 38 and two output melt channel portions shown at 39a and 39b.

With continued reference to FIG. 2, each of the hot runner nozzles 200 includes a nozzle head portion 12, a nozzle head lip portion 19, a nozzle body portion 21 and a nozzle tip portion 23. The nozzles 200 each further include at least one nozzle tip 14 having a nozzle tip melt channel 3 therethrough, and an associated nozzle tip seal 16. The nozzle tip melt channel 3 forms at least part of the output melt channel portion 39. In the embodiment shown in FIG. 2, there is a small portion of the output melt channel portion 39 that resides in the nozzle tip portion 23.

A nozzle heater shown at 36 is secured to each hot runner nozzle 200 for heating melt passing through the nozzle 200. Optionally a plurality of nozzle heaters are secured to each hot runner nozzle 200. The nozzle heater 36 may be any suitable type of nozzle heater known in the art, such as a resistance heater as is commonly used in hot runner injection nozzles.

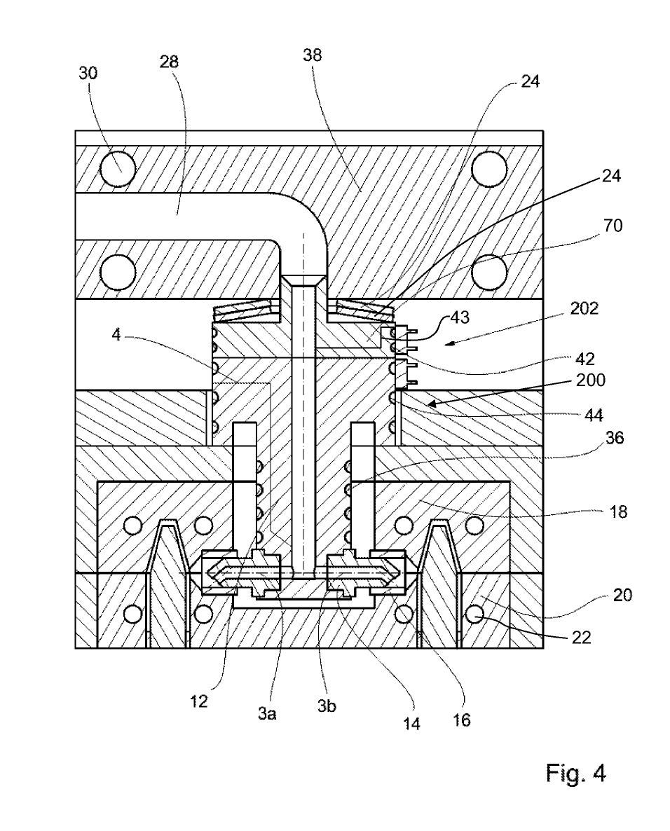

A nozzle temperature sensor (e.g., a thermocouple) shown at 4 in FIG. 4 may be secured to each hot runner nozzle 200 so as to permit the control system (not shown) to determine the temperature of melt in the nozzle 200.

A mold, shown generally at 62, includes the first and second mold plates 62a and 62b, and further includes a third mold plate 62c and a fourth mold plate 62d. The third and fourth mold plates 62c and 62d include a set of first and second mold plate inserts shown at 62e and 62f respectively. The inserts 62e and 62f together cooperate with mold cores 62g and sleeves 62h to define a plurality of mold cavities 66. In the example shown, a plurality of sets of inserts 62e and 62f are provided, each set being associated with two mold cavities 66, and one hot runner nozzle 200. In another embodiment (shown in FIG. 12), each set of inserts 62e and 62f could be associated with a single mold cavity, and with one hot runner nozzle 200.

A plurality of mold cooling passages 22 are provided in the mold 62 (specifically in the inserts 62e and 62f in the embodiment shown in FIG. 1a), to permit the flow of coolant therethrough for cooling the mold 62 in order to solidify the melt in the mold cavities 66.

In both FIGS. 2 and 12, the plurality of mold cavities 66 are positioned to receive molten material (which may also be referred to as melt) from the plurality of the side gating hot runner nozzles 200, such that each mold cavity 66 has at least one mold gate orifice 82 having a mold gate orifice axis AG, that opens into a mold gate opening 84 that receives one of the nozzle tips 14 and seals 16. The fit between the nozzle tip seals 16 and the mold gate openings 84 and between the nozzle tips 14 and the tip seals 16 is sufficiently tight to inhibit the leakage of melt therepast into the mold well 68 in the mold 62 in which the nozzles 200 sit.

The engagement of the nozzle tips 14 with the tip seals 16 and the engagement of the tip seals 16 with the mold gate openings 84 serves to fix the position of the nozzle 200 axially and laterally and also fixes the lower end of the nozzle 200 so that, when heated, the nozzle 200 generally grows upwards towards the manifold 10 during thermal expansion.

In all the embodiments of the present disclosure and also as shown in detail with continued reference to FIG. 2, a plurality of floating manifold seals 70 are coupled to the manifold 10. Each floating seal 70 is positioned between the manifold 10 and one of the nozzle head portions 12, and has a floating seal melt channel 72 to convey melt from one of the manifold output melt channels 13 to the nozzle input melt channel portion 38 of one of the nozzles 200.

The floating seal 70 is telescopically connected to the manifold 10. In the embodiment shown, the floating seal 70 includes an extension 71 that projects into the manifold 10 to bring the floating seal melt channel 72 into fluid communication with the associated manifold output melt channel 13. In an alternative embodiment, the manifold 10 could have an extension that projects into the floating seal 70 to bring the manifold output melt channel 13 into fluid communication with the floating seal melt channel 72. The telescopic connection permits the floating seal 70 and the manifold 10 to be movable axially (i.e., in a direction parallel to the longitudinal molding apparatus axis AM) relative to each other. Thus the telescopic connection permits the floating seal 70 to be movable axially relative to the manifold 10 during thermal expansion of the nozzles 200, and also permits the manifold 10 to be movable axially relative to the floating seal 70 during thermal expansion and contraction of the manifold 10.

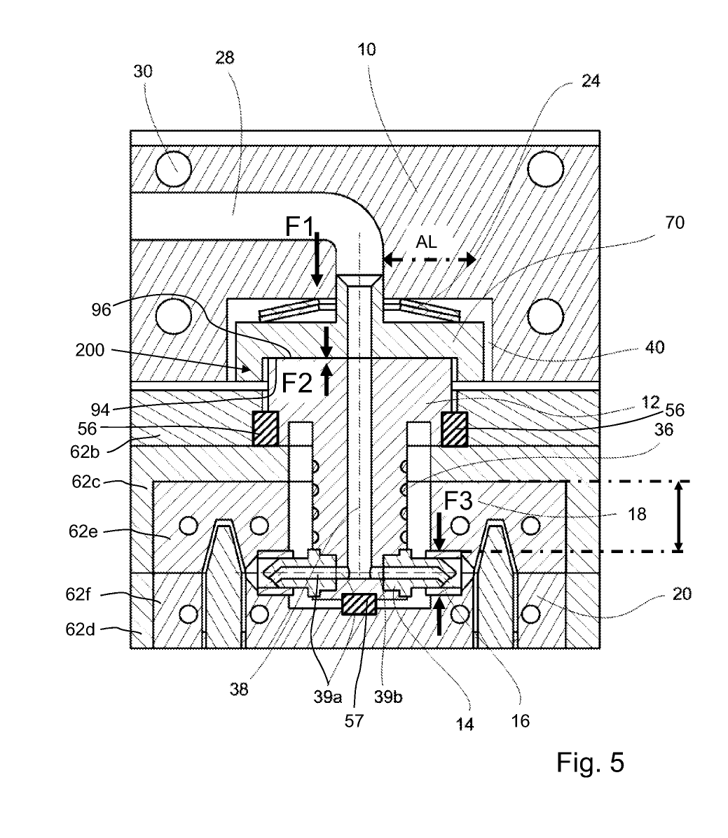

Additionally, the telescopic connection (i.e., the axial penetration of one of the floating seal 70 and the manifold 10 into the other of the floating seal 70 and the manifold 10), in combination with the fact that the floating seal is laterally movable relative to the nozzle 200, permits the floating manifold seals 70 to be movable together with the manifold 10 along a lateral direction, (shown by direction line AL in FIG. 5) during thermal expansion and contraction of the manifold 10, even though the nozzle 200 is not movable laterally (i.e., is fixed in position laterally).

In all the embodiments of the present disclosure, a plurality of floating seal biasing elements 24 are positioned in an axial gap 40 between the manifold 10 and the floating manifold seals 70. The biasing elements 24 apply a biasing force to urge the floating seal 70 away from the manifold 10 and into engagement with the nozzles 200, thereby improving a sealing effect at the interface between the floating seal 70 and the nozzle 200, which is between the first and second interface surfaces shown at 94 and 96. In other words, the sealing effect between the manifold seals 70 and the nozzles 200 is related to the biasing force applied by the biasing elements 24. As the biasing force increases, the sealing effect improves.

The injection molding apparatus 100 may be configured so that the biasing elements 24 are preloaded by a selected amount upon assembly of the apparatus 100, so that at all times during its operation, the floating seal 70 is urged against the nozzle 200 with at least a selected force so as to maintain a seal therebetween.

In the embodiment shown in FIG. 1a, a plurality of manifold biasing elements 99 are provided between the surfaces 15a and 60. These biasing elements 99 urge the manifold 10 away from the mold plate 62a and downwards towards the floating seals 70. The biasing elements 99 and 24 suspend the manifold 10 between the surfaces 60 and 64 of the mold 62 so as to maintain an air gap between the mold 62 and the surface 60 and 64 to inhibit heat transfer out of the manifold 10 into the mold 62.

Pins 101 extend from the surface 60 of the mold plate 62a into the manifold 10. Additionally, a locating member 32 extends from surface 15b the manifold 10 into the mold plate 62b. The pins 101 and the locating member 32 cooperate to locate the manifold 10 laterally relative to the mold 62 while permitting axial movement between the manifold 10 and the mold 62 thereby accommodating relative shrinkage and expansion between the manifold 10 and the mold 62 due to changes in their respective temperatures.

It will be noted that, as the temperature of the manifold 10 it grows axially towards the nozzle 200. This reduces the size of the axial gap 40, thereby causing increased flexure of the biasing elements 24. This increased flexure causes an increase in the force exerted by the biasing elements 24 on the floating seal 70 against the nozzle 200. It will also be noted that, as the manifold 10 heats up, the temperature of the melt flowing through and out of the manifold 10 increases, which, in turn, causes a decrease in the viscosity of the melt. This decrease in viscosity would, all things being equal, make it more likely to result in leakage at the interface between the floating seal 70 and the nozzle 200. However, the increase in the force exerted on the floating seal 70 by the biasing elements 24 improves the seal at the interface, at least partially offsetting the increased likelihood of leakage. Thus, as the melt temperature increases, there may be no increase or only a small increase in the likelihood of melt leakage between the floating seal 70 and the nozzle 200. Similarly, as the temperature of the nozzle 200 increases, it grows axially towards the manifold 10. This growth similarly causes increased flexure of the biasing elements 24, which in turn, causes an increase in the force of engagement between the floating seal 70 and the nozzle 200, thereby improving the seal therebetween, which at least partially offsets any increase in likelihood of leakage of melt therebetween due to a decrease in viscosity that accompanies an increase in melt temperature (which would result from an increase in the temperature of the nozzle 200). Thus, the structure shown in at least some embodiments herein addresses the problem of how to provide a hot runner injection molding apparatus with a hot runner manifold, side gated hot runner nozzles and seal members, which accommodates thermal expansion of the manifold both laterally and axially and thermal expansion of the hot runner nozzles axially upwards, while also maintaining a strong seal between the nozzles and the seals during operation.

The biasing elements 24 may be said to absorb the thermal expansion of both the manifold 10 and the nozzles 200 to generate a sealing force between the nozzle head portion 12 and the lower surface 94 of the floating manifold seals 70 when the nozzles 200.

It will be noted that, in the embodiment shown in FIG. 1a, the floating manifold seals 70 make lateral contact with the manifold 10 so as to be heated by the manifold 10. In other words, there is engagement between a laterally peripheral surface 103 of the floating seal 70 and a corresponding mating surface 105 of the manifold 10. The engagement of these surfaces 103 and 105 permits heat transfer from the manifold 10 into the seal 70 to assist in keeping the melt heated as it passes through the seal 70 into the nozzle 200. In such embodiments, the seal 70 may be made from a material that is more thermally conductive than the material of the manifold 10 so as to promote heat transfer from the nozzle head 12 to the seal 70. Alternatively the seal 70 may be made from a material that is less thermally conductive than the material of the manifold 10 so as to reduce the heat transfer from the manifold 10 into the seal 70. Thus, the seal 70 may be made of a material that has different characteristics (e.g., a different thermal conductivity) than the material of the manifold 10.

While it is advantageous for packaging reasons to provide the biasing elements 24 in the axial gap 40, they may be positioned elsewhere, while still urging the seal 70 away from the manifold 10 and into engagement with the nozzle 200.

It will be noted that the nozzle 200 may be substantially unchanged in design regardless of whether or not the floating seal 70 is provided. In other words, a manufacture can maintain a common design of nozzle that can be used both on apparatuses that include floating seals 70 and apparatuses that do not include floating seals. This reduces the complexity of modifying the design of an injection molding apparatus to include the floating seals 70 in order to accommodate thermal expansion laterally of the manifold 10, thermal expansion axially of the nozzle 200 and thermal expansion axially of the manifold 10, while also providing a strong seal between the nozzles 200 and the floating seals 70. Furthermore, in situations where the design of the apparatus 100 changes such that the stack height of the mold plates 62a, 62b, 62c and 62d changes, the change in the stack height can easily be accommodated by a change in the thickness of the floating seals 70.

The biasing elements 24 also maintain an axial spacing between the manifold 10 and the seal 70 which controls heat loss from the manifold 10 into the seal 70.

While there are a plurality of such biasing elements 24 shown in FIG. 2, there may be as few as one floating seal biasing element 24 between the manifold and each floating seal 70.

The nozzle 200 includes a mold engagement surface 90 which is engageable with a nozzle support surface 92 in the mold 62 to limit the axial movement of the nozzle 200 into the mold well 68 when axial forces are exerted on the nozzle 200 (e.g., from the melt in the nozzle 200) and from the manifold 10, through the floating seal biasing elements 24.

The mold engagement surface 90 may be provided on a nozzle extension member 19 in the embodiment shown in FIG. 2. This extension member 19 may be configured to flex resiliently during engagement of the mold engagement surface 90 with the nozzle support surface 92 so as to urge the nozzle 200 upwards into engagement with the floating seal 70 when incurring forces from the melt and from thermal expansion of the manifold 10. This can improve the seal at the interface between the floating seal 70 and the nozzle 200.

As shown in FIG. 1b, an optional second manifold biasing element shown at 36 may be provided in an axial gap 107 between the locating member 32 and the mold plate 62c. This biasing element 36 assists in urging the manifold 10 away from surface 64 of the mold 62.

As shown in FIG. 1c, the manifold 10 may be configured to have no direct engagement with the floating seals 70, thereby avoiding heat transfer from the manifold 10 into the seals 70 (i.e., thermally insulating the manifold 10 from the seals 70). In such an embodiment, it is optionally possible to provide a separate floating seal heater 42, as shown in FIG. 4, for the floating seal 202. The heater 42 may be a resistance heater, similar to the heater 36 on the nozzle 200. In such an embodiment the seal 70 may be made from a thermally conductive material without concern of significant heat transfer into the seal 70 from the manifold since, aside from the telescopic connection therebetween there is no direct contact between the seal 70 and the manifold 10. Additionally, it will be noted that the resistance heater 44 of the nozzle 200 also heats the head 12 of the nozzle 200 in FIGS. 4, 6, 7 and 9. Optionally, a seal temperature sensor 43 may be provided, as shown in FIG. 4, which may be, for example, a thermocouple.

FIG. 2b is an exploded view of a portion of the apparatus 100.

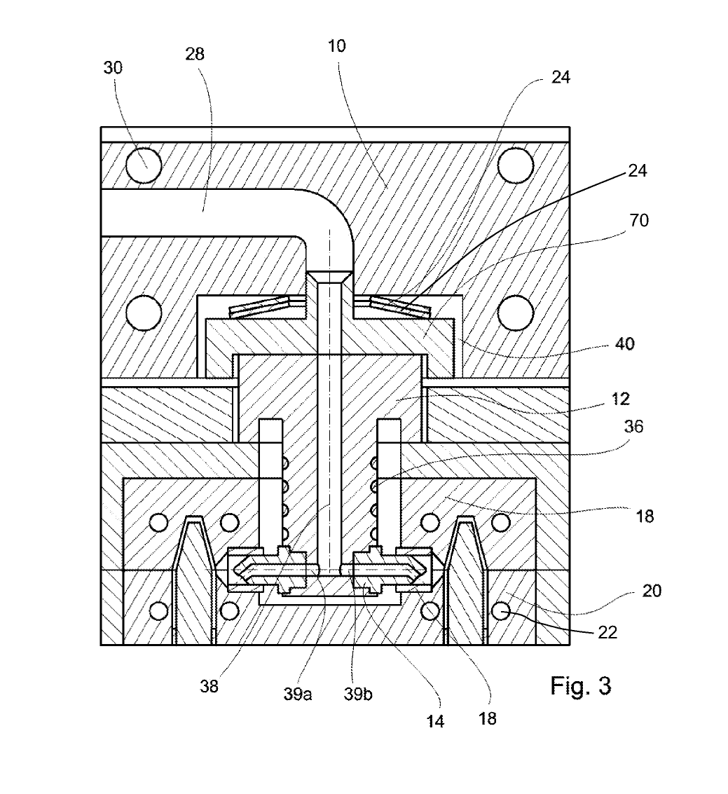

FIG. 3 shows an alternative embodiment in which there is the gap 40 is both axial and lateral. As a result, in similar fashion to the embodiments shown in FIGS. 1c and 4, heat transfer between the manifold 10 and the seal 70 is avoided.

FIG. 5 illustrates some of the forces that result during thermal expansion of the manifold 10 and the nozzle 200. The force F1 results from the manifold's thermal expansion and urges the seal 70 downwards through compression of the biasing elements 24. The force F2 results from upward growth of the nozzle 200 during thermal expansion thereof which drives the nozzle 200 into the seal 70, thereby improving the performance of the sealing effect therebetween. Element 203 is shown and assists in locating the top of the nozzle 200 laterally and also may be made from a thermally insulative material to reduce heat transfer from the nozzle 200 into the mold plates 62b and 62c.

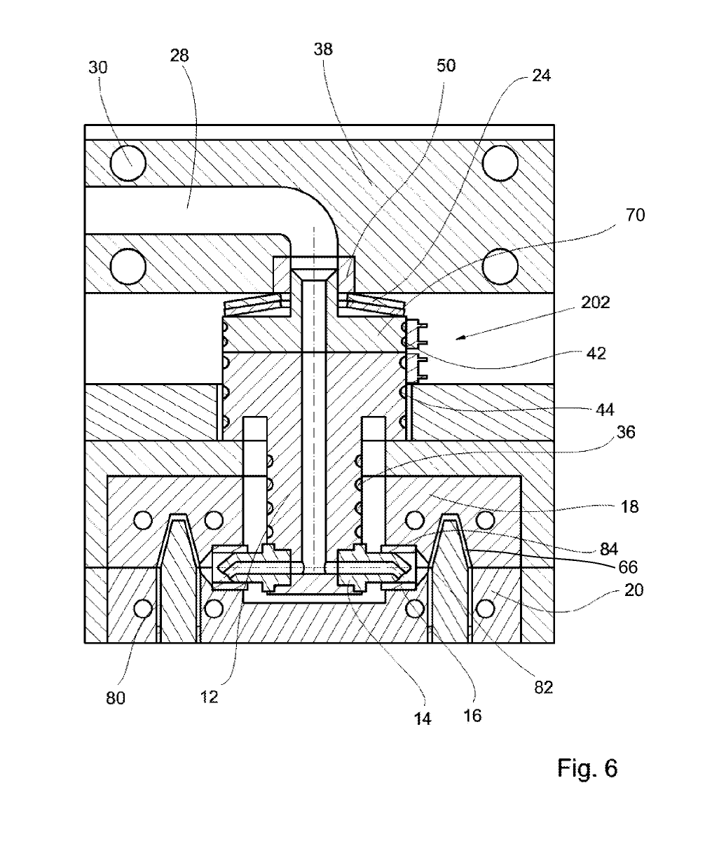

FIG. 6 is similar to FIG. 4, but also shows an additional manifold insert 50 that receives the extension 71 of the floating seal 70 and which may be made from a material that has reduced friction to facilitate sliding at the telescopic connection. The insert 50 also may form a better sealing effect with the extension 71 of the seal 70 than is formed between the extension 71 directly with the material of the manifold 10. The insert 50 may also be made form an insulative material to reduce heat transfer from the manifold 10 into the seal 70. The material of the seal 70 may have a high thermal conductivity in such a case, in order to receive heat from the nozzle 200, while being insulated from receiving heat from the manifold 10. FIG. 6 also shows that a second heater element 42 is coupled to or associated with floating seal 70. This provides another possibility of adjusting the temperature of the melt from one nozzle to another in order to compensate for some heat loss at the nozzle head 12 or flange.

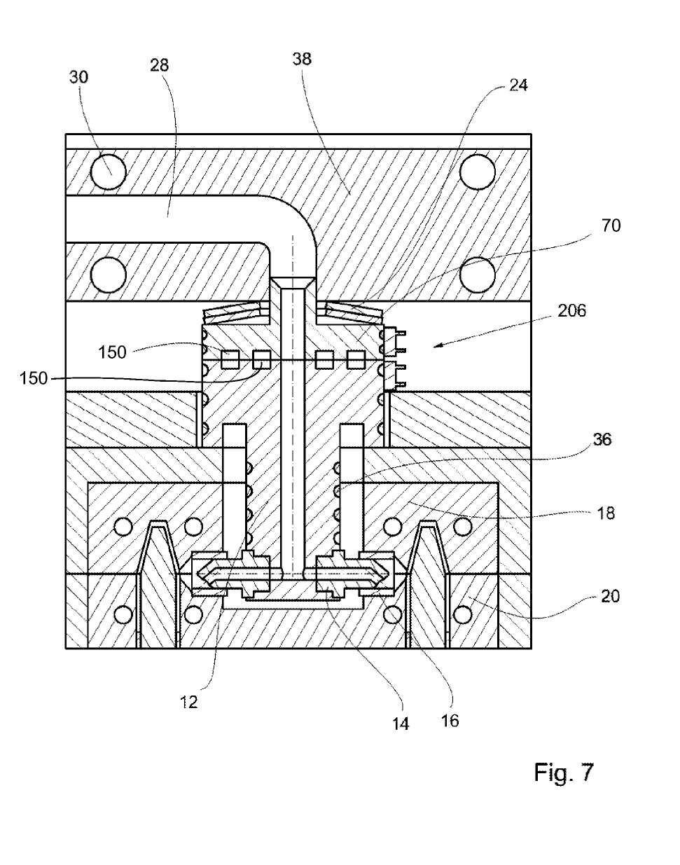

FIG. 7 is similar to FIG. 6 but shows some air pockets 150 used to reduce the contact surface between the seal 70 and the nozzle head 12 to facilitate the lateral sliding of the manifold 10. These air pockets 150 may also retain some of the leaked resin when the sealing between the nozzle 200 and the seal 70 is less efficient.

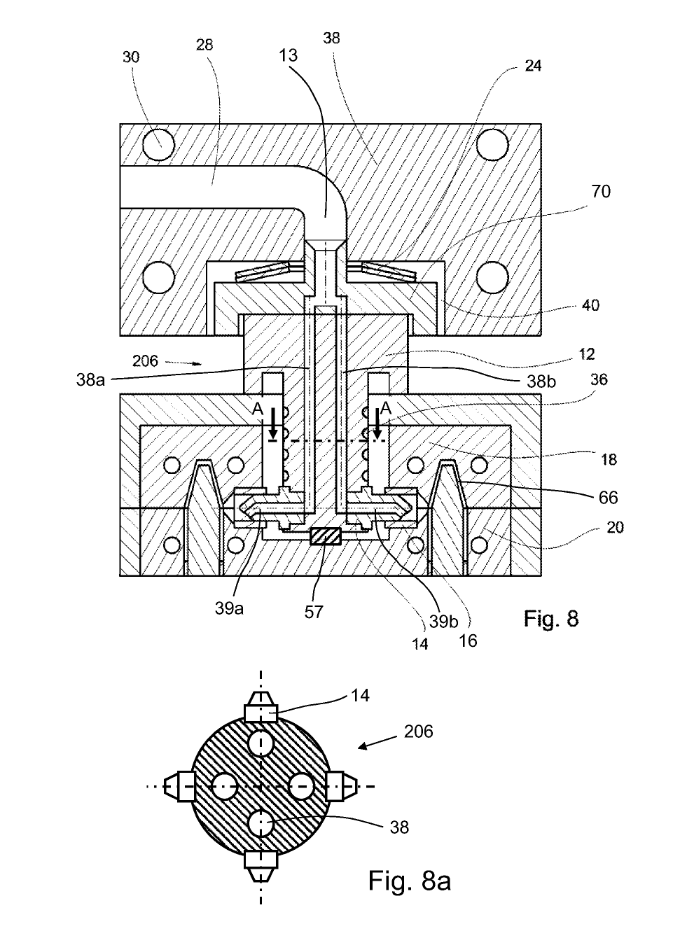

FIG. 8 is similar to FIG. 2, but has a nozzle 206 instead of nozzle 200. Nozzle 206 may be similar to nozzle 200 except that it contains two separate melt channels throughout, (i.e., two separate melt channel portions 38a and 38b which feed melt channel portions 39a and 39b). The melt channel 72 in the seal 70 includes an input melt channel portion 77 that divides into two output melt channels 75a and 75b, which feed melt channel portions 38a and 38b individually. The shut off pins 205 of FIG. 11 can be used for each channel to block the flow of melt on an individual basis.

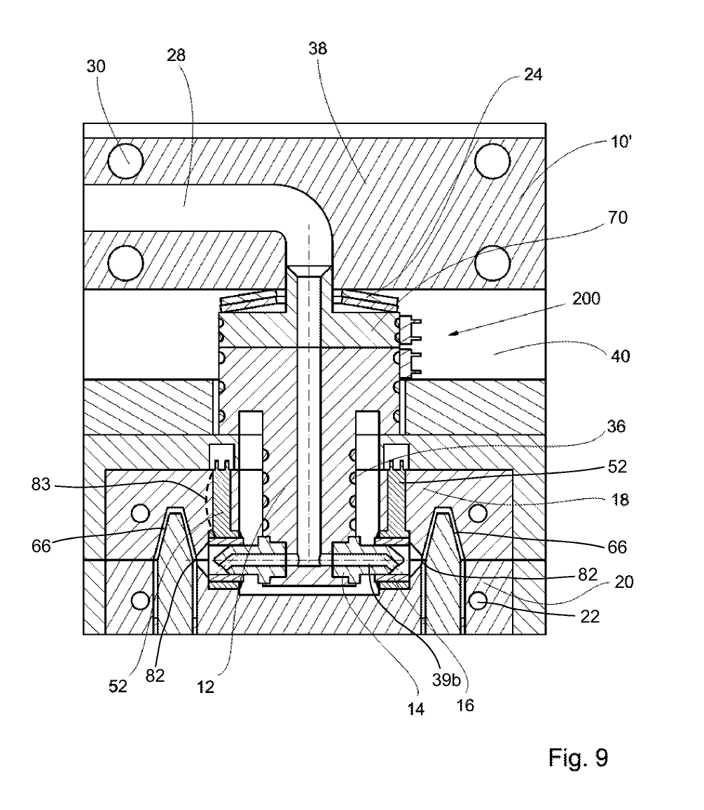

In another aspect of the present disclosure shown in FIGS. 1a-b-c-d-e the embodiment of FIG. 9 is somehow similar to FIG. 6 and FIG. 7, but further includes a nozzle tips heater or a mold gate areas heater shown at 52 in association with each mold gate 82. The mold gate area heater 52 may be any suitable type of heater, such as a resistance heater. The heater 52 may be provided in surrounding relationship to the seal 16. Additionally, mold gate temperature sensors 83 (e.g., thermocouples) may be provided for sensing the temperature of the melt at the mold gates 82. The use of separate heaters for the tips or for the gate areas provides an additional level of control of the temperature suitable for specific heat sensitive resins, also for the start-up period where there is a need to have an initial time dedicated to bring the system in the injection ready position to avoid leakage of material around the nozzle tips. In some embodiments of the present disclosure not shown, the side gating nozzles are not operated in conjunction with floating manifold seals 70 and associated biasing elements 24 but they include heaters 52 as shown in FIG. 9.

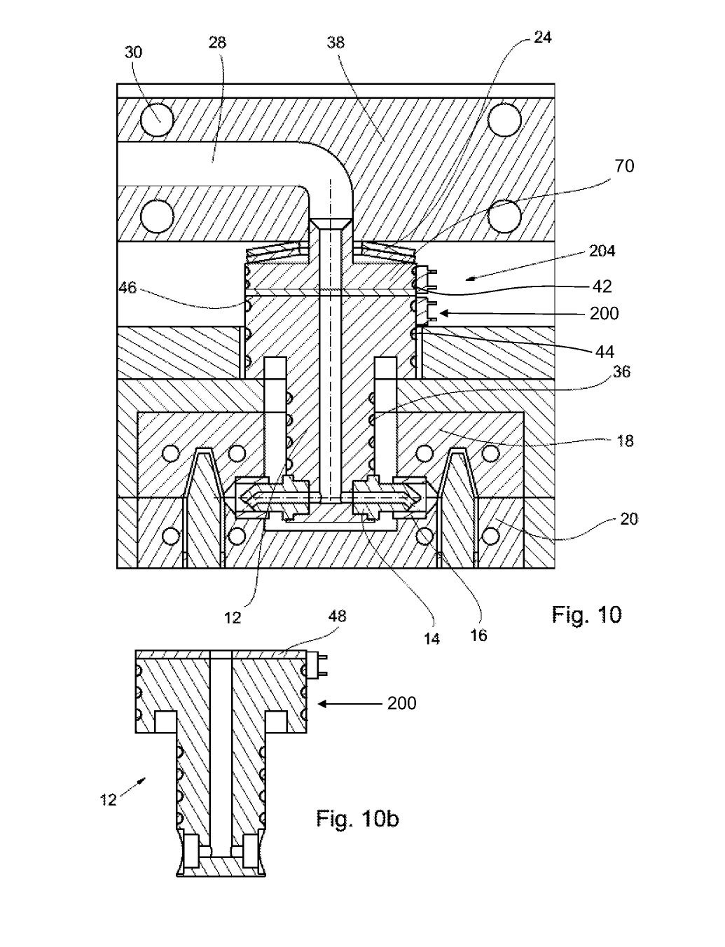

FIG. 10 is similar to FIGS. 6, 7 9, but further includes an intermediate cover layer 46 on a seal 204 or on the nozzle head 12. The cover layer 46 may be made from any suitable material such as a high wear resistance material. The cover layer 46 may provide reduced sliding friction between the seal 204 and the nozzle 200 so as to facilitate lateral movement of the seal 204 during thermal expansion of the manifold 10. Additionally, the cover layer 46 may have better wear characteristics than the seal 70 and may provide improved sealing performance between the seal 204 and the nozzle 200. To achieve improved sliding characteristics the cover layer 46 may have a finer surface roughness relative to the roughness of the element that it covers. In this embodiment, the thermal conductivity of the seal 204 may be high. Alternatively, the thermal conductivity of the seal 204 may be low.

A cover layer could alternatively be provided on the nozzle 200 instead of, or in addition to, being provided on the seal 70, as shown at 48 in FIG. 10b.

Referring to FIG. 11, a single manifold seal 70 is connected to a plurality of nozzles 200. Each nozzle 200 may be similar to the nozzle 200 shown in FIG. 2 except that as shown in FIG. 11, each nozzle 200 includes a single tip 14 that feeds a single mold cavity 66. Two biasing elements 24 urge the manifold seal 70 away from the manifold 10, as in the embodiments shown in FIGS. 2-10. In other words, no more biasing elements 24 are used in the embodiment shown in FIG. 11 than are used in the embodiments shown in FIGS. 2-10.

The arrangement shown in FIG. 11 has the advantage of a separate nozzle heater 36 for each nozzle, whereas the embodiment in FIG. 8 includes a single heater that is used to heat one nozzle that has two separate nozzle melt channels. The separate heaters permit individual control over the temperatures of the individual nozzles 200 to address temperature differences that may exist in the melt in the different nozzles 200. In the embodiment shown, the melt channel 72 in the seal 70 includes an input melt channel portion 77 that divides into four output melt channel portions (two of which are shown at 75a and 75b), which feed melt to four nozzles 200, although only three nozzles 200 are shown as FIG. 11 is a sectional view. The three nozzles shown are shown individually at 200a, 200b and 200c. However, it will be understood that as many as few as two, and as many as eight or more nozzles could be provided to receive melt from the single manifold seal 70 (in which case, the melt channel 72 would include the appropriate number of output melt channel portions).

The embodiment of FIG. 11 has also the advantage of being able to stop one nozzle 200 and thus one cavity by turning off the heater 36 of that nozzle 200, or alternatively via a mechanical shut off device. An example of a mechanical shut off device may be a shut off pin 205 (FIG. 11b) that can be positioned to block flow through the nozzle melt channel portion 38 of the nozzle melt channel. In the embodiment shown in FIG. 11b the pin 205 is manually introduced by a machine operator.

Alternatively the shut off pin 205 can be activated remotely via the control system (not shown), without a stoppage of production and without a need to open the mold. Such an embodiment is shown in FIG. 11c. In one embodiment shown in FIG. 11c, the shut off pin 205 is preloaded by a spring 207 or equivalent to apply a continuous force F to the pin 205 towards the closed position. However, a stopping element 209 such as a solenoid, may keep the shut off pin 205 outside the nozzle melt channel. The pin 205 is shown in the open position in FIG. 11c and is thus outside the melt channel. Based on the information from a processing sensor or by manually pushing a button on a controller, the stopping element 209 is destroyed or deactivated (e.g., withdrawn) so as to permit the spring 207 to drive the pin 205 forward into the nozzle melt channel to the closed position to block the flow of melt to that respective gate 82).

The floating manifold seal 70 may be configured as shown in FIG. 6, wherein it has a separate heater 42. Additionally or alternatively, for some applications, additional separate heaters such as those shown at 52 in FIG. 9 are placed at the mold gate opening 84 around the nozzle tip seals.

In the embodiment shown in FIG. 11, the nozzles 200 feed melt laterally into a mold cavity 66. This can lead, however, to an unbalanced force from the injection pressure of the melt in the output melt channel portion shown at 39. It is optionally possible to configure the nozzles 200 of FIG. 11, to have melt channel portions 38 that split into two opposing output melt channel portions 39, wherein one of the melt channel portions 39 leads to the mold cavity 66, and the other one leads to a ‘dummy’ tip (not shown) that is similar to tip 14 but is blind and therefore does not permit the discharge of melt therefrom. This can better balance the forces on the nozzle 200 resulting from the injection pressure of the melt and can facilitate better positioning of the nozzle 200.

For some applications, several clusters of nozzles 200 such as shown in FIG. 11 can be coupled to a single floating manifold seal 70 and a single set of two biasing elements 24 can be coupled to urge the manifold seal 70 away from the manifold 10. Optionally, two nozzles 200 can be configured to feed a single mold cavity 66 from opposite directions (not shown).

In an embodiment the nozzle 200 may be installed from the front and the nozzle tips and seal are located in the gate area.

The arrangement shown in FIG. 11 has the advantage of a separate nozzle heater 36 for each nozzle, whereas the embodiment in FIG. 8 includes a single heater that is used to heat one nozzle that has two separate nozzle melt channels. The separate heaters permit individual control over the temperatures of the individual nozzles 200 to address temperature differences that may exist in the melt in the different nozzles 200. In the embodiment shown, the melt channel 72 in the seal 70 includes an input melt channel portion 77 that divides into four output melt channel portions (two of which are shown at 75a and 75b), which feed melt to four nozzles 200, although only three nozzles 200 are shown as FIG. 11 is a sectional view. The three nozzles shown are shown individually at 200a, 200b and 200c. However, it will be understood that as many as few as two, and as many as eight or more nozzles could be provided to receive melt from the single manifold seal 70 (in which case, the melt channel 72 would include the appropriate number of output melt channel portions).

Some of the elements described herein are identified explicitly as being optional, while other elements are not identified in this way. Even if not identified as such, it will be noted that, in some embodiments, some of these other elements are not intended to be interpreted as being necessary, and would be understood by one skilled in the art as being optional.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An injection molding apparatus for side gating moldable articles comprising:
an injection manifold having at least one manifold input melt channel and a plurality of manifold output melt channels, the manifold being heated by at least one manifold heater controlled by at least one manifold thermocouple, and wherein the manifold has an upper surface, an opposite lower surface and a lateral surface;
a plurality of side gating hot runner nozzles coupled to the manifold, each side gating hot runner nozzle including at least one input melt channel portion having a first axis and at least one output melt channel portion having a second axis, the second axis being inclined relative to the first axis, and wherein each of the hot runner nozzles includes a nozzle head portion, a nozzle body portion and a nozzle tip portion, the nozzles further including at least one nozzle tip having a nozzle tip melt channel and an associated nozzle tip seal;
a plurality of nozzle heaters and nozzle thermocouples secured to each hot runner nozzle;
a plurality of mold cavities positioned to receive molten material from the plurality of the side gating hot runner nozzles, each mold cavity having at least one mold gate orifice having a third axis and a mold gate opening to receive the nozzle tip seals;
a plurality of floating manifold seals coupled to the manifold, the floating manifold seals being movable together with the manifold along a first lateral direction with respect to the fixed nozzles as a result of a thermal expansion of the manifold and being further movable relative to the manifold along a second direction as a result of thermal expansion of the nozzles, where each of the floating manifold seals being positioned between the manifold and each nozzle head portion; and
a plurality of biasing elements positioned in a gap or a pocket between the manifold and an upper surface of the floating manifold seals, the biasing elements holding the manifold and absorbing the thermal expansion of both the manifold and the nozzles to generate a first sealing force between the nozzle head portion and the lower surface of the floating manifold seals when the nozzles, that are locked in a fixed position by the nozzle head flanges and by nozzle tips seals and when the manifold, that are supported by the biasing elements and by the nozzle heads, are heated up.

2. The injection molding apparatus of claim 1, wherein the floating manifold seal further includes a telescopic or sliding portion having a melt channel extension that protrudes and is movable inside the output melt channels of the manifold.

3. The injection molding apparatus of claim 1, wherein the floating manifold seals are made of a material that have different characteristics than the material of the manifold.

4. The injection molding apparatus of claim 1, wherein the floating manifold seals are made of a material having lower thermal conductivity than the material of the manifold.

5. The injection molding apparatus of claim 1, wherein the floating manifold seals are made of a material having higher thermal conductivity than the material of the manifold.

6. The injection molding apparatus of claim 1, wherein the floating manifold seals are made of a material having higher wear resistance than the material of the manifold.

7. The injection molding apparatus of claim 1, wherein the floating manifold seals are made of two materials having different material characteristics.

8. The injection molding apparatus of claim 7, wherein the floating manifold seals are made of a first material having high thermal conductivity and a second material that has higher wear resistance characteristics.

9. The injection molding apparatus of claim 1, wherein the floating manifold seals have a seating surface and sealing surface having a roughness different than the roughness of the manifold lower surface.

10. The injection molding apparatus of claim 1, wherein the floating manifold seals make lateral contact with the manifold to be heated by the manifold.

11. The injection molding apparatus of claim 1, wherein the floating manifold seals make no contact with the manifold in order to be insulated from the manifold.

12. The injection molding apparatus of claim 1, wherein the floating manifold seals include a separate heater and temperature sensor.

13. The injection molding apparatus of claim 1, wherein the manifold includes an air pocket at the output manifold melt channels to receive the floating manifold seals in order to reduce the thickness of the manifold;

14. The injection molding apparatus of claim 1, wherein the floating manifold seals includes at least one air pocket between the manifold seal and the nozzle head in order to reduce the thickness of the manifold seal and nozzle as an assembly.

15. The injection molding apparatus of claim 1, wherein the floating manifold seals include an input melt channel portion and a plurality of output melt channel portions to distribute molten material to a plurality of melt channels of a single nozzle.

16. The injection molding apparatus of claim 1, wherein each floating manifold seal includes an input melt channel portion and a plurality of output melt channel portions to distribute molten material to a plurality separate side gating nozzles.

17. The injection molding apparatus of claim 1, further comprising a separate heater and thermocouple positioned at the mold gate area to provide additional heating to the nozzle tips.

18. An injection molding apparatus for side gating moldable articles in mold cavities, comprising:
an injection manifold having at least one manifold input melt channel and a plurality of manifold output melt channels, the manifold being heated by at least one manifold heater controlled by at least one manifold temperature sensor, and wherein the manifold has a distal-facing surface relative to the mold cavities and an opposite proximal-facing surface;
a plurality of side gating hot runner nozzles, each including at least one input melt channel portion having a first axis, and wherein each of the hot runner nozzles includes a nozzle head portion, a nozzle body portion, a nozzle tip portion, at least one nozzle tip at least partially defining an output melt channel having a second axis that is inclined relative to the first axis, and a nozzle tip seal in association with each nozzle tip, wherein each nozzle includes at least one nozzle heater positioned to heat melt in the nozzle, and at least one nozzle temperature sensor positioned to sense the temperature of the nozzle, wherein each nozzle tip and tip seal are positionable in a mold gate opening proximate a mold gate orifice into an associated one of the mold cavities, so as to fix the position of the nozzle laterally and axially;
a plurality of floating manifold seals positioned between the manifold and the nozzle head portions of the nozzles to transfer melt from the manifold into the nozzles, wherein the manifold seals are telescopically connected to the manifold so as to permit relative axial movement between each floating manifold seal and the manifold, wherein the telescopic connection causes each manifold seal to move with the manifold laterally during thermal expansion and contraction of the manifold, wherein the telescopic connection permits axial movement of the manifold relative to each manifold seal during thermal expansion and contraction of the manifold and also permits axial movement of each manifold seal relative to the manifold a result of thermal expansion of the nozzles; and
a plurality of biasing elements positioned to apply a biasing force to urge the floating manifold seals away from the manifold and into engagement with the nozzles.

19. The injection molding apparatus of claim 18, wherein the biasing elements are positioned to undergo increased flexure as the temperature of at least one of the manifold and the nozzles increases, thereby increasing the biasing force with which the floating manifold seals are urged into engagement with the nozzles, wherein a sealing effect between the manifold seals and the nozzles is related to the biasing force.

20. The injection molding apparatus of claim 18, wherein, aside from the telescopic connection between the manifold seals and the manifold, there is no direct contact between each manifold seal and the manifold.

21. The injection molding apparatus of claim 18, wherein there is no direct contact between each manifold seal and the manifold.

22. The injection molding apparatus of claim 18, wherein the telescopic connection comprises an extension on each manifold seal that penetrates the manifold.

23. A side gating hot runner apparatus comprising:
a manifold having a melt inlet and a plurality of melt outlets;
a hot runner nozzle having a nozzle head and including a main melt channel and at least two angled melt channels communicating with at least two nozzle tips, each tip being retained in a fix position around a corresponding mold gate;
a first nozzle heater;
a nozzle to manifold seal located between the nozzle and the manifold, the seal including a telescopic extension movable inside a manifold outlet; and
a biasing element located between the manifold seal and the manifold that applies a sealing force between the nozzle head and the manifold seal and where the nozzle seal moves without restriction laterally and vertically due to thermal expansion.

24. A method of sealing a hot runner apparatus for side gating comprising:
providing a manifold having a plurality of melt outlets;
providing a plurality of side gating hot runner nozzle communicating with the outlets, each nozzle including at least one laterally positioned tip locked at a mold gate;
providing a manifold seal between the nozzle and the manifold, the manifold having a telescopic or sliding connection penetrating a manifold outlet;
providing a biasing element between the manifold seal and the manifold and using the biasing element to create a sealing force between the nozzle and the seal while allowing the manifold to slide along a first direction and the nozzle seal to slide along a second direction perpendicular to the first direction.
